(19) United States
(12) Patent Application Publication
(10) Pub. No.: US 2026/0295867 A1
(43) Pub. Date: Oct. 1, 2026

(54) Mechanically Actuated Robotic Tool Changer with Configurable Manual Actuation Lock-out

(71) Applicant: ATI Industrial Automation, Inc., Apex, NC (US)

(72) Inventors: Baron Kendrick, Holly Springs, NC (US); Nathan Brace, Fuquay-Varina, NC (US)

(21) Appl. No.: 19/575,301

(22) Filed: Mar. 23, 2026

Related U.S. Application Data
(60) Provisional application No. 63/777,064, filed on Mar. 25, 2025.

(51) Int. Cl. B25J 15/04

(52) U.S. Cl. CPC B25J 15/0425; B25J 15/0491

(57) ABSTRACT

A mechanically actuated tool changer comprises a robot unit comprising a locking post having an engagement cap, and a tool unit having a central recess to accept the locking post in a decoupled state. In a coupled state, the effective diameter of the central recess is reduced, capturing the engagement cap of the locking post. The coupling mechanism comprises a pair of geometrically identical sliding wedges, arranged in an inverted and longitudinally opposite orientation relative to each other. Mainsprings bias the sliding wedges apart, reducing the effective diameter of the central recess. To decouple, engagement edges of the sliding wedges are moved together, against the bias of the mainsprings. The engagement edges are pressed together as the tool unit is placed in a tool stand. A configurable manual actuation lock-out mechanism selectable allows or prevents manual actuation of the coupling mechanism.

### RELATED APPLICATIONS

This application claims the benefit of U.S. Provisional Application No. 63/777064, filed Mar. 25, 2025, the disclosure of is hereby incorporated by reference herein, in its entirety.

### FIELD OF DISCLOSURE

The present disclosure relates generally to robotic tool changers, and in particular to a mechanically robotic tool changer that is coupled by default, is automatically decoupled by docking in an associated tool stand, and is configurable whether it can be manually decoupled when removed from the tool stand.

### BACKGROUND

Industrial robots have become an indispensable part of modern manufacturing. Whether transferring semiconductor wafers from one process chamber to another in a cleanroom or cutting and welding steel on the floor of an automobile manufacturing plant, robots perform many manufacturing tasks tirelessly, in hostile environments, and with high precision and repeatability.

In many robotic manufacturing applications, it is cost-effective to utilize a relatively generic robot arm to accomplish a variety of tasks. For example, in an automotive manufacturing application, a robot arm may be utilized to cut, grind, or otherwise shape metal parts during one phase of production, and perform a variety of welding tasks in another. Different welding tool geometries may be advantageously mated to a particular robot arm to perform welding tasks at different locations or in different orientations.

In these applications, a tool changer is used to mate different tools to the robot. One half of the tool changer, called the master unit, is permanently affixed to a robot arm. The other half, called the tool unit, is affixed to each tool that the robot may utilize. When the robot arm positions the master unit adjacent a tool unit connected to a desired tool, a coupling mechanism is actuated that mechanically locks the master and tool units together, thus affixing the tool to the end of the robot arm. The tool changer thus provides a consistent mechanical interface between a robot arm and a variety of robotic tools. A tool changer may also pass utilities to a tool.

Robotic tools may require utilities, such as electrical current, air pressure, hydraulic fluid, cooling water, electronic or optical data signals, and the like, for operation. Connections to these utilities may be unwieldy, or even unsafe, in operation. Additionally, if two or more tools require the same utilities, a dedicated connection to each tool would be duplicative. Accordingly, one important function of a robotic tool changer is to provide utility-passing modules. Such modules may be attached to standardized locations on the master and tool units of the robotic tool changer. The modules include mating terminals, valve connections, electrical connectors, and the like, making the utilities available to the selected tool when it is coupled to the robot arm. Many tool changers include one or more standard-sized “flats” about their periphery, to which various utility-passing modules may be attached, as required. Tool changers and utility-passing modules are well known in the robotics arts, and are commercially available, such as from the assignee, ATI Industrial Automation of Apex, N.C.

When not in use, each robotic tool is stored in a special rack, or tool holder, within the operative range of the robotic arm. Robot arm controller software “remembers” where each tool is, and each tool is returned to precisely the same position in its tool holder prior to the tool changer decoupling. Similarly, the robot arm controller software “knows” precisely where the next desired tool is stored, and it positions the master unit of the tool changer (on the robot arm) adjacent the tool unit (on the desired tool), then actuates the tool changer to couple the tool to the robot arm.

Conventionally, the master unit of a robotic tool changer includes a coupling mechanism, which may be powered electrically, pneumatically, hydraulically, etc., under the control of a robot controller that controls the robot arm movement. Such robotic tool changers are described, for example, in U.S. Pat. Nos. 7,252,453; 8,005,570; 8,209,840; 8,601,667; 8,832,816; 10,335,957; 10,661,449; 11,691,294; 10,759,061 and 11,850,733, all assigned to the assignee of the present disclosure, and the disclosure of each of which is incorporated by reference herein in its entirety.

Mechanically actuated robotic tool changers are class of tool changers in which the coupling mechanism does not require a power source. Some mechanical tool changers are actuated by humans; others are actuated automatically, such as by interaction with a tool stand. Some mechanically actuated robotic tool changers are described, for example, in U.S. Pat. Nos. 7,779,716; 8,500,132; 8,533,930; 8,857,821; and 9,724,830, all assigned to the assignee of the present disclosure, and the disclosure of each of which is incorporated by reference herein in its entirety.

Mechanically actuated robotic tool changers are of particular utility in the growing field of collaborative robots, or cobots, which are designed to work in close proximity to humans, and include safety features to enable such collaboration. Cobots, and the robotic tools they deploy, are generally smaller and lighter than industrial robots. The primary advantages of mechanically actuated tool changers include increased productivity, enhanced flexibility, cost savings, and improved safety without the use of auxiliary power sources.

Automatically actuated mechanical tool changers boost throughput and efficiency by reducing the downtime associated with manual tool changes. Like all robotic tool changers, they allow a single robot to perform multiple tasks, reducing the need for multiple specialized robots, with concomitant cost savings. Additionally, automated tool changing minimizes human intervention in hazardous environments, enhancing workplace safety.

In some applications, it is desirable for humans to be able to actuate mechanical tool changers, to change robotic tools during an operation, without requiring the robot to return to a tool stand and perform the tool change. Manually actuated mechanical tool changers are not allowed, however, in some robotic installations with strict safety standards, which require a robotic tool changer to decouple only when a robotic tool is safely stored in a tool stand.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a mechanically actuated tool changer comprises a robot unit configured to be connected to an actuator and a tool unit configured to be connected to a robotic tool. A locking post having an engagement cap protrudes from the robot unit. The tool unit includes a central recess sized and configured to accept the locking post in a decoupled state, as the robot unit moves to abut the tool unit. In a coupled state, the effective diameter of the central recess is reduced, capturing the engagement cap of the locking post and coupling the tool unit to the robot unit. The coupling mechanism comprise a pair of geometrically identical sliding wedges, arranged in an inverted and longitudinally opposite orientation relative to each other. Mainsprings bias the sliding wedges apart, reducing the effective diameter of the central recess. To decouple, engagement edges of the sliding wedges, protruding from the sides of the tool unit housing, are moved together, against the bias of the mainsprings. The engagement edges are pressed together as the tool unit is placed in a tool stand. By default, a manual actuation lock-out mechanism prevents the engagement edges from being moved, to decouple the units, anytime the tool unit leaves tool stand. The manual actuation lock-out mechanism can be configured to be inactive, allowing manual actuation of the tool unit if so required or desired.

One embodiment relates to a mechanically actuated robotic tool changer system. The system includes a robot unit configured to be connected to an actuator and comprising a locking post. The system also includes a tool unit configured to be connected to a robotic tool and comprising a pair of geometrically identical sliding wedges in inverted and longitudinal opposite configuration to each other. The sliding wedges are biased apart from each other to assume a coupled state, in which the locking post of the robot unit is captured to couple the tool unit to the robot unit. The sliding wedges are moveable towards each other to assume a decoupled state, in which the locking post of the robot unit is released. The system further includes a tool stand configured to hold and support the tool unit and attached robotic tool. The tool stand is configured to press the sliding wedges towards each other, to place the tool unit in a decoupled state.

Another embodiment relates to a mechanically actuated robotic tool changer. The tool changer includes a robot unit configured to be connected to an actuator and comprising a locking post. The tool changer further includes a tool unit having a housing and configured to be connected to a robotic tool, having a central recess, and comprising a pair of geometrically identical sliding wedges in inverted and longitudinally opposite configuration to each other. The sliding wedges are biased apart from each other to assume a default coupled state in which the locking post of the robot unit is captured in the central recess of the tool unit to couple the tool unit to the robot unit, and the sliding wedges are moveable towards each other to assume a decoupled state in which the locking post of the robot unit is released. The tool changer further includes a manual actuation lock-out mechanism configured to disable manual actuation of the sliding wedges from the coupled state to the decoupled state, wherein actuation of the sliding wedges from the coupled state to the decoupled state can only occur by placing the tool unit in an associated tool stand.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a perspective view of a robot unit and a tool unit of a mechanically actuated tool changer.

FIG. 2 is a perspective view of the robotic tool changer with the tool unit disposed in a tool stand.

FIG. 3 is a plan view of the tool unit disposed in the tool stand.

FIG. 4 is a perspective view of one sliding wedge.

FIG. 5 is a perspective view of the sliding wedge from a different vantage point.

FIG. 6 is a perspective view of two sliding wedges in inverted and longitudinally opposite configuration to each other, with bias mainsprings.

FIG. 7 is a plan sectional view of the tool unit in a decoupled state.

FIG. 8 is a plan sectional view of the tool unit in a coupled state.

FIG. 9 is a perspective view of two sliding wedges, one in the position of a coupled state and the other in the position of a decoupled state, with manually actuated lock-out pins.

FIG. 10 is a partial perspective section view a sliding wedge and manually actuated lock-out pin.

FIG. 11 is a partial section view showing the tool unit in the coupled state and the manual actuation lock-out pin preventing manual actuation to the decoupled state.

FIG. 12 is a partial section view showing the tool unit partially disposed in the tool stand, with the ramp moving the manual actuation lock-out pin to allow the tool unit to assume the decoupled state.

FIG. 13 is a partial section view showing a set screw installed in the tool unit, which prevents the manual actuation lock-out pin from moving to a position that would prevent manual actuation of the tool unit to assume the decoupled state.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

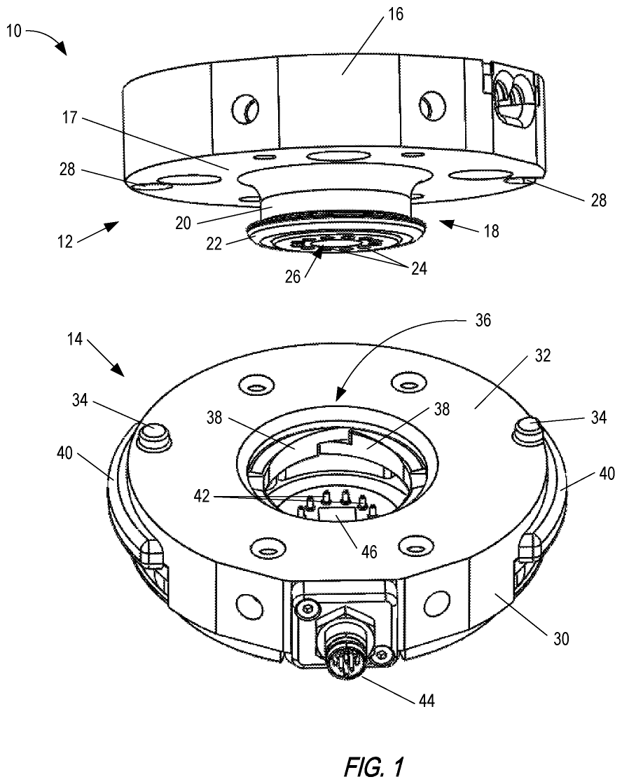

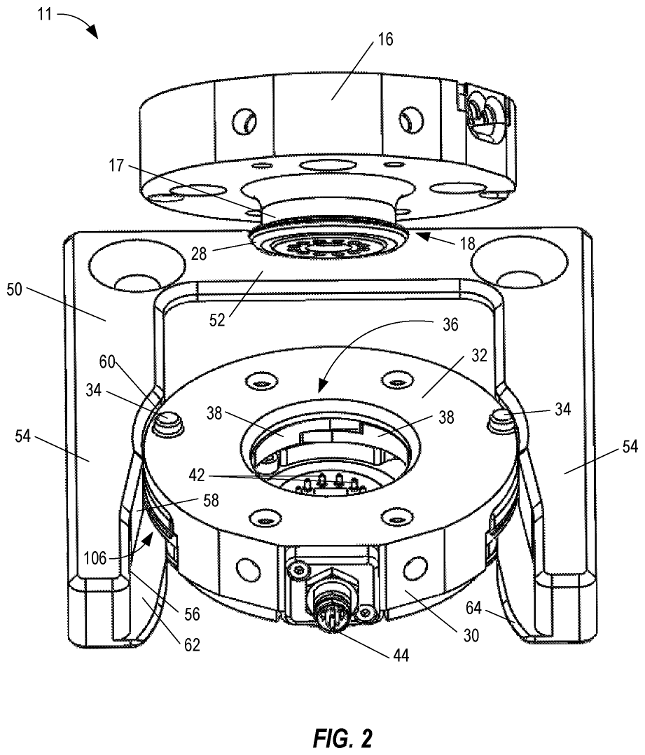

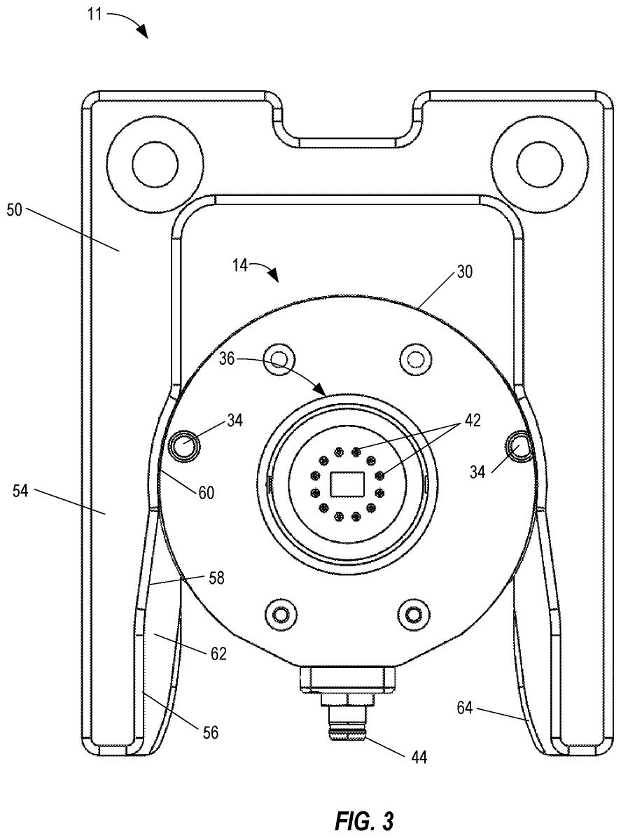

FIG. 1 depicts a mechanically actuated robotic tool changer 10 according to aspects of the present disclosure, and FIGS. 2 and 3 depict a mechanically actuated robotic tool changer system 11, including the tool changer 10 and an associated tool stand 50. The tool changer 10 comprises a robot unit 12 configured to be attached to an actuator such as a robot arm (not shown), and a tool unit 14 configured to be attached to a robotic tool (not shown). A mechanically actuated coupling mechanism in the tool unit 14 is biased to a coupled state, in which it maintains a secure mechanical connection between the tool unit 14 and the robot unit 12, coupling an attached robotic tool to the robot arm. The default state of the coupling mechanism is coupled. The coupling mechanism is automatically moved to a decoupled position, in which the robot unit 12 may separate from the tool unit 14, by mechanical interaction with an associated tool stand (see FIG. 2). As described more fully herein, the tool unit 14 may be configured to enable decoupling by human interaction, or it may be configured to decouple only by tool stand interaction.

The robot unit 12 comprises a housing 16, having a generally flat mating face 17. A locking post 18 extends from the housing 16 beyond the mating face 17. The locking post 18 includes a locking shaft 20 having a first diameter, and an engagement cap 22 rigidly affixed to the locking shaft 20 and having a second diameter greater than the first diameter. In one aspect, a plurality of contacts 24 is positioned around the engagement cap 22. The contacts 24 may, for example, comprise electrical or optical contacts configured to pass data signals between the tool unit 12 and tool unit 14. In other aspects, the contacts 24 may be replaced with pneumatic couplings, or otherwise be configured to pass various utilities between the tool unit 12 and tool unit 14. In one aspect, a central bore 26 extends through the locking post 18 and housing 16, allowing for cables, pneumatic or hydraulic fluid lines, or other components to pass through the robot unit 12. Alignment pin receptacles 28 accept corresponding alignment pins 34 on the tool unit, ensuring a repeatable alignment of the robot unit 12 and tool unit 14 during each coupling.

As well known in the art, the housing 16 may include mounting holes or otherwise provide for mechanically affixing the housing 16 to an actuator, such as a robot arm. The mounting holes may conform to a standard defining size and placement, allowing the robot unit 12 to be readily affixed to a variety of deployed robot arms or other actuators. As also well known in the art of robotic tool changers, various utility-passing modules may be selectively affixed to the robot unit 12, enabling the passage of utilities between the robot unit 12 and tool unit 14.

FIG. 1 shows the tool unit 14 is its default coupled state, but not coupled to the robot unit 12 for the purpose of showing its parts and describing its operation. In normal operation, in the coupled state the tool unit 14 would be coupled to the robot unit 12. FIG. 2 shows the tool unit 14 disposed in a corresponding tool stand 50. Mechanical interaction between the tool unit 14 and the tool stand 50 transitions the tool unit 14 to a decoupled state when it is disposed in the tool stand. The tool unit 14 automatically transitions to the coupled state when it is removed from the tool stand 50.

Referring to FIG. 1, The tool unit 12 comprises a housing 30, having a generally flat mating face 32. Alignment pins 34 protrude from the mating face 32, and are disposed in corresponding alignment pin receptacles 28 in the mating face 17 of the robot unit 12 when the units 12, 14 abut. A central recess 36 in the housing 30 accepts the locking post 18 of the robot unit 12 when the tool unit 14 is in the decoupled state and the robot and tool units 12, 14 abut. FIG. 1 shows the tool unit 12 in the coupled state, wherein engagement surfaces 38 of sliding wedges (not fully visible in FIG. 1) within the housing 30 of the tool unit 14 are moved towards each other, reducing the effective diameter of the central bore 36. FIG. 2 shows the tool unit 14 in the decoupled state, wherein engagement surfaces 38 are moved away from each other, increasing the effective diameter of the central bore 36.

If the locking post 18 of a robot unit 12 is disposed within the central recess 36 when the tool unit 14 is in the decoupled state—e.g., disposed within a tool stand 50 as shown in FIG. 2—then upon removal from the tool stand, the tool unit 14 assumes the coupled state. In the coupled state, the engagement surfaces 38 of the sliding wedges assume the positions shown in FIG. 1, trapping the engagement cap 22 of the locking post 18, and thus coupling the robot unit 12 and tool unit 14 together. The sliding wedges are biased to the coupled position, such as by springs, and hence, the coupled state is the default state of the tool unit 14. In the coupled state, actuating edges 40 of the sliding wedges protrude from the sides of the housing 30, as shown in FIG. 1.

When the tool unit 14 is disposed in the tool stand 50 to assume the decoupled state (FIGS. 2, 3), the actuating edges 40 are pressed inwardly, becoming flush with the housing 30. This action moves the engagement surfaces 38 apart, increasing the effective diameter of the central recess 36 and releasing the locking post 18.

Referring again to FIG. 1, In one aspect, pins 42 are disposed within the housing 30 and within the central recess 36, and positioned so as to mate with contacts 24 on the engagement cap 22 of the locking post 18. As described above, the pins 42 may comprise electrical or optical connectors configured to pass data signals between the tool unit 12 and tool unit 14. A multi-conductor electrical or optical connector 44, affixed to the side of the housing 30, provides operative connection to the pins 42. In other aspects, the pins 42 may be replaced with pneumatic couplings, or otherwise be configured to pass various utilities between the tool unit 12 and tool unit 14. In one aspect, a bore 46—aligned with the central bore 26 of the robot unit 12—extends through the housing 30, allowing for cables, pneumatic or hydraulic fluid lines, or other components to pass through the tool unit 12.

The tool stand 50, shown in perspective view in FIG. 2 and plan view in FIG. 3, has the general shape of a two-tine fork, comprising a base 52, and two opposed fork arms 54. As best shown in FIG. 3, the inner surface of each fork arm 54 comprises a plurality of distinct surfaces. At the outermost extent, an engagement surface 56 accepts the tool unit 14 and guides it into the center of the tool stand 50. An angled decoupling surface 58 is angled so as to decrease the distance between the inner walls of the two fork arms 54 as the tool unit 14 moves into the tool stand. This progressively depresses the actuating edges 40, which protrude from the housing 30 when the tool unit 14 is in the coupled state, transitioning the tool unit 14 to the decoupled state as the tool unit 14 moves further into the tool stand 50. An arcuate holding surface 60 is shaped to conform to the outer diameter of the housing 30, and holds the tool unit 14 when it is fully inserted into the tool stand 50, at which point the tool unit 14 has assumed the fully decoupled state and releases the locking post 18 of the robot unit 12. The engagement surface 56, angled decoupling surface 58, and arcuate holding surface 60 are vertical surfaces.

A horizontal support shelf 62 extends horizontally inwardly at the lower extent of the engagement surface 56, angled decoupling surface 58, and arcuate holding surface 60. The horizontal support shelf 62 engages a tool stand slot 106 in the tool unit 14 as the tool unit 14 enters the tool stand 50. The horizontal support shelf 62 supports the weight of the tool unit 14 and attached robotic tool when the tool unit 14 is in the decoupled state, and the robot arm no longer supports them.

A ramp 62 formed in the inner edge of the horizontal support shelf 62 gradually transitions from a distance below the upper surface of the horizontal support shelf 62 at the front of the engagement surface 56, to being even with the upper surface of the horizontal support shelf 62 (and hence disappearing) at the back of the angled decoupling surface 58. That is, the ramp 62 does not exist in the horizontal support shelf 62 along the arcuate holding surface 60. As discussed further herein, the ramp 62 engages and lifts a manual actuation lock-out pin (not shown) in the tool unit 14 as the tool unit 14 moves into the tool stand 50, allowing the coupling mechanism to assume the decoupled state in a manual actuation lock-out configuration.

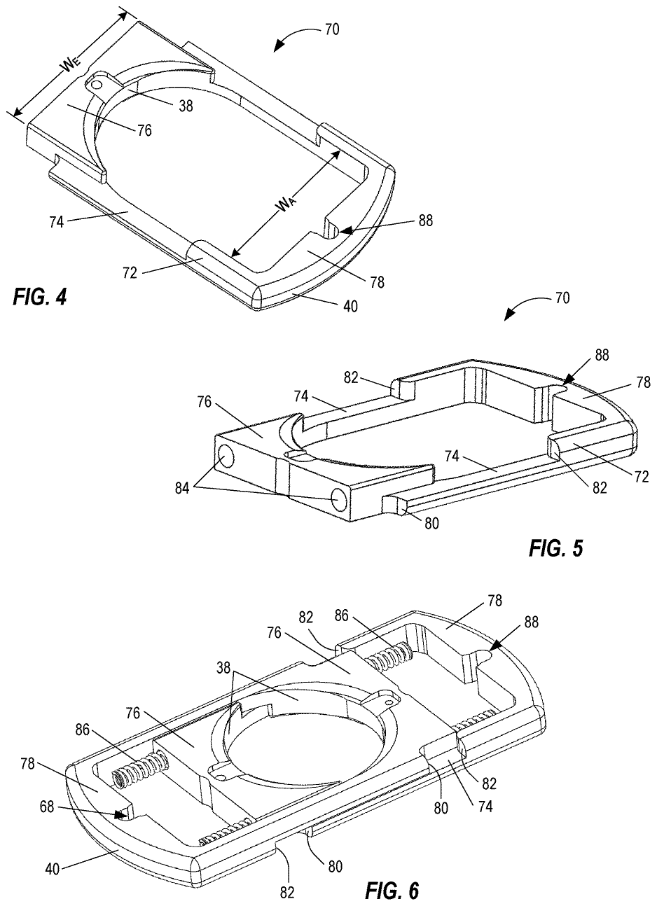

The key to the mechanically actuated coupling mechanism in the tool unit 14 is a pair of geometrically identical sliding wedges 70, one of which is depicted in FIGS. 4 and 5. FIG. 6 depicts two sliding wedges, with mainsprings 86 installed, in an inverted and longitudinally opposite configuration. The sliding wedge 70 is preferably machined from a single piece of metal. The sliding wedge 70 includes an engagement end 76, with the engagement surface 38 (visible in FIG. 1) formed on the inner edge, and an actuating end 78, with the actuating edge 40 (also visible in FIG. 1) formed as the outer edge. The engagement end 76 and actuating end 78 are connected by side rails 72. Each side rail 72 includes a slide surface 74 that extends only partially along the length of the side rail 72.

The engagement end 76 of the sliding wedge 70 has a width W_{E} that is slightly less than a width W_{A} of the interior of the opposite actuating end 78. Accordingly, when a second sliding wedge 70 is inverted and oriented oppositely along its length to a first sliding wedge 70, the engagement end 76 of the second wedge 70 will fit within the interior space in the actuating end 78 of the first wedge 70, and vice versa, as shown in FIG. 6.

FIG. 5 shows a Cartesian coordinate system for reference. As used herein, sliding wedges 70 being in “inverted” orientation to each other means their upper faces or surfaces, shown facing up in FIGS. 4 and 5, face in opposite z-axis directions. In an inverted relative orientation, the slide surfaces 74 of the side rails 72 of the two sliding wedges 70 touch, and the wedges 70 slide with respect to each other longitudinally (in the y-axis direction) on the slide surfaces 74. As used herein, sliding wedges 70 being in “longitudinally opposite” orientation to each other means they are aligned in opposite directions along the y-axis. That is, as described above and as shown in FIG. 6, the engagement end 76 of one sliding wedge 70 is positioned adjacent to (and may slide into and out of the interior space of) the actuating end 78 of the other sliding wedge 70, and vice versa. As used herein, sliding wedges 70 being “geometrically identical” means they have the same size and shape. The two sliding wedges 70 in a tool unit 14 are two copies, or instantiations, of the same part.

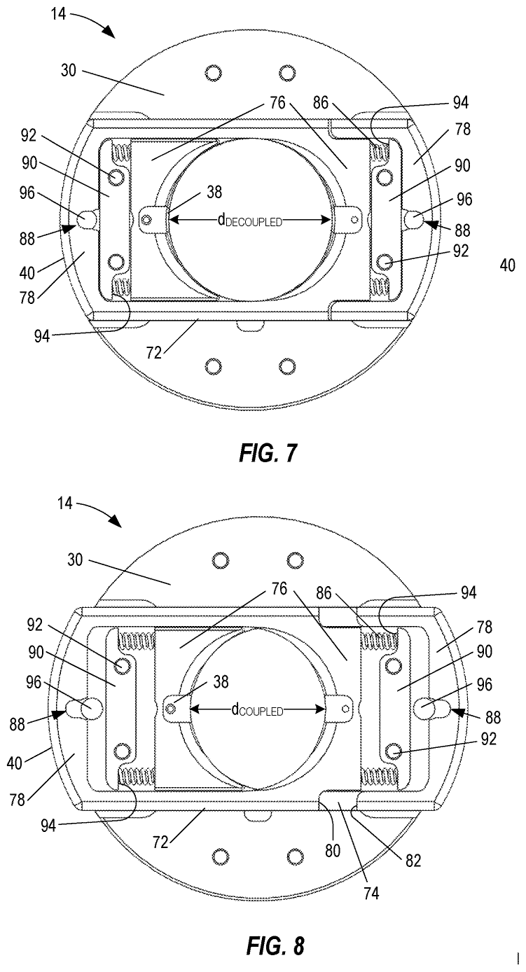

As best seen in FIG. 7, each side rail 72 extends from the actuating edge 40 of the actuating end 78 to a point shy of the end of the sliding wedge 70 at the engagement end 76. At this point, the side rail 72 terminates in a first mating face 80. As noted above, the slide surface 74 extends only partially along the side rail 72 on the other end, and it terminates forming a second mating face 82. As shown in FIG. 6, when two sliding wedges 70 are mated in inverted and opposite longitudinal orientation, the first and second mating faces 80, 82 abut when the engagement end 76 of one wedge 70 is slid within the actuating edge 40 of the other wedge 70, and vice versa.

FIG. 5 shows two mainspring retention bores 84 formed in the engagement end 76. As shown in FIG. 6, these retain mainsprings 86, which bias the two sliding wedges apart, pushing the actuating edges 40 apart, and drawing the engagement surfaces 38 together. This bias makes the coupled position of the tool unit 14, shown in FIG. 1, the default state. The decoupled state is only achieved by pressing the actuating edges 40 together, against the bias of the four mainsprings 86. As discussed above, this occurs upon sliding the tool unit 14 into the tool stand 50, but it also occurs by a human pressing both actuating edges 40 inwardly, so they are flush with the sides of the housing 30.

Manual actuation lock-out slot 88, formed in the actuating end 78 of each sliding wedge 70, is part of a manual actuation lock-out mechanism, described more fully herein below.

FIG. 7 is a section view showing the tool unit 14 in a decoupled state, such as it assumes when stowed in a tool stand 50 or is manually actuated, and FIG. 8 shows the tool unit 14 in its default coupled state. In the decoupled state of FIG. 7, the tool unit 14 central recess 36 has a first effective diameter d_{DECOUPLED}, measured between the engagement surfaces 38 of the two sliding wedges 70. In the coupled state of FIG. 8, the tool unit 14 central recess 36 has a second effective diameter d_{COUPLED}, which is smaller than the first effective diameter d_{DECOUPLED}. The term “effective” diameter refers to the diameter of a circular object that can pass through the non-circular opening formed in the coupled state of FIG. 8. The first effective diameter d_{DECOUPLED} is larger than the diameter of the engagement cap 22 of the locking post 18 of the robot unit 12 (FIGS. 1, 2). The second effective diameter d_{COUPLED} is smaller than the diameter of the engagement cap 22, but larger than the diameter of the locking shaft 20 of the locking post 18. Accordingly, the locking post 18 may move into the central recess 36 when the tool unit 14 is in the decoupled state, but the engagement surfaces 38, spaced at the second effective diameter d_{COUPLED} in the coupled state, capture the engagement cap 22 of the locking post 18, thus coupling the tool unit 14 to the robot unit 12. In one aspect, the sliding wedges are sized and positioned such that if only one of the actuating edges 40 is depressed, the resulting effective diameter (between d_{DECOUPLED} and d_{COUPLED}) is still smaller than the diameter of the engagement cap 22, thus still retaining the engagement cap 22, although it may be able to withstand lower applied forces before an undesired decoupling occurs, compared to the fully coupled state.

Newly shown in FIGS. 7 and 8, compared to FIGS. 4-6, are mainspring grounding blocks 90 and manual actuation lock-out pins 96. Mainspring grounding blocks 90 are rigidly attached to the tool unit 14 housing 30, such as by fasteners 92 installed in through-holes. Each mainspring grounding block 90 includes two mainspring grounding surfaces 94, sized and oriented to provide a grounding, or abutting, surface for mainsprings 86. The mainsprings 86 are thus mechanically grounded against the housing 30 at one end, and against the sliding wedges 70 at the other end (disposed in mainspring retention bores 84 in the engagement ends 76 of the sliding wedges 70). The mainsprings 86 thus bias each sliding wedge 70 outwardly, away from the center of the housing 30, and bias the engagement surfaces 38 of each sliding wedge 70 inwardly, towards the fully coupled position of FIG. 8.

In some deployment scenarios, strict safety regulations require that a robotic tool changer can only decouple when the attached robotic tool is properly stowed in a tool stand. In these environments, regulations require that actuation of the coupling mechanism, to transition the tool changer from a coupled to a decoupled state, must be physically/mechanically blocked from occurring due to anything other than the tool stand. That is, both human actuation of the coupling mechanism, and accidental actuation due to the robot inadvertently bumping into another object (referred to as a crash), must be physically/mechanically impossible. In other deployment scenarios, such as where robotic tools are lightweight, and are changed often during use, it is advantageous for humans to be able to actuate a robotic tool changer to decouple and remove one robotic tool, and to attach and couple a different robotic tool. These incompatible requirements conventionally require different designs, and customers must choose between tool-stand-only actuation models and tool-stand-or-human actuation models.

According to embodiments of the present disclosure, the robotic tool changer 10 and tool stand 50 include a configurable manual actuation lock-out mechanism. In the tool unit 14, the manual actuation lock-out mechanism comprises a manual actuation lock-out slot 88 formed in the actuating end 78 of each sliding wedge 70 (FIGS. 4-9) and the manual actuation lock-out pin 96 (FIGS. 7, 8). In the tool stand 50, the ramp 64 in the support surface 62 interacts with the manual actuation lock-out pin 96 to allow tool stand actuation to the decoupled state.

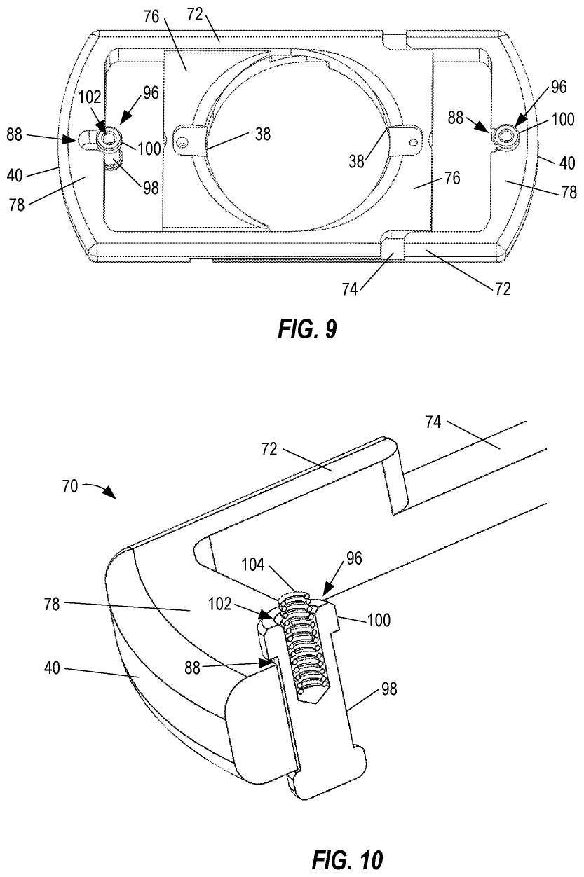

FIG. 9 shows the interaction between the manual actuation lock-out pin 96 and the manual actuation lock-out slot 88. FIG. 9 shows a hybrid state of the coupling mechanism, not normally encountered in use, which is shown for the purpose of explaining the manual actuation lock-out mechanism. In particular, FIG. 9 shows the actuation edge 40 on the right depressed (moved inwardly), as in the decoupled state, while the actuation edge 40 on the left is extended, as in the coupled state. This shows that the manual actuation lock-out pin 96 does not engage the manual actuation lock-out slot 88 in the coupled state (left side of FIG. 9), and the manual actuation lock-out pin 96 is disposed within the manual actuation lock-out slot 88 in the decoupled state (right side of FIG. 9).

As best seen in the section view of FIG. 10, the manual actuation lock-out pin 96 comprises a central shaft 98 having a first diameter and a lock-out cap 100 having a second diameter larger than the first diameter. In particular, the diameter of the central shaft 98 is less than the width of the manual actuation lock-out slot 88, and the diameter of the lock-out cap 100 is greater than the width of the manual actuation lock-out slot 88. FIG. 10 shows the central shaft 98 of the manual actuation lock-out pin 96 disposed within the manual actuation lock-out slot 88.

The left side of FIG. 9 shows one of the sliding wedges 70 in the coupled state, with the actuating edge 40 extended outwardly, and the manual actuation lock-out pin 96 spaced apart from the manual actuation lock-out slot 88. The manual actuation lock-out pin 96 is movable in a longitudinal direction that is transverse to the plane of the sliding wedge 70 (i.e., in a vertical direction when the sliding wedge 70 is horizontal). The manual actuation lock-out pin 96 may assume a first longitudinal position, wherein the smaller diameter central shaft 98 is aligned with the manual actuation lock-out slot 88, as shown in FIG. 9. In this position, when the actuating edge 40 is pushed inwardly into the housing 30, the sliding wedge 70 moves inwardly, and the manual actuation lock-out slot 88 captures the central shaft 98 of the manual actuation lock-out pin 96, as show in FIG. 10 and the right side of FIG. 9. In this first longitudinal position of the manual actuation lock-out pin 96, the tool changer 10 may be actuated from the coupled state to the decoupled state manually, i.e., when the tool unit 14 is out of the tool stand 50. Alternatively, the manual actuation lock-out pin 96 may assume a second longitudinal position, wherein the larger diameter lock-out cap 100 is aligned with the manual actuation lock-out slot 88. In this case, regardless of pressure applied to the actuation edge 40, the sliding wedge 70 cannot move inwardly within the housing 30, as the manual actuation lock-out slot 88 cannot move to encompass the larger-diameter lock-out cap 100. In this second longitudinal position, the tool changer 10 cannot be manually actuated from the coupled state to the decoupled state. As discussed further herein, the tool changer 10 in this configuration can only be decoupled when placed in the tool stand 50.

A lock-out pin spring retention bore 102 is formed in the manual actuation lock-out pin 96, which holds a lock-out pin spring 104 that biases the manual actuation lock-out pin 96 towards the second longitudinal position (downwardly, as shown in FIG. 10). This places the lock-out cap 100 adjacent the manual actuation lock-out slot 88, preventing, or locking out, any possibility of manual actuation. Manual actuation lock-out—that is, the manual actuation lock-out pin 96 assuming the second longitudinal position—is the default state of the tool unit 14.

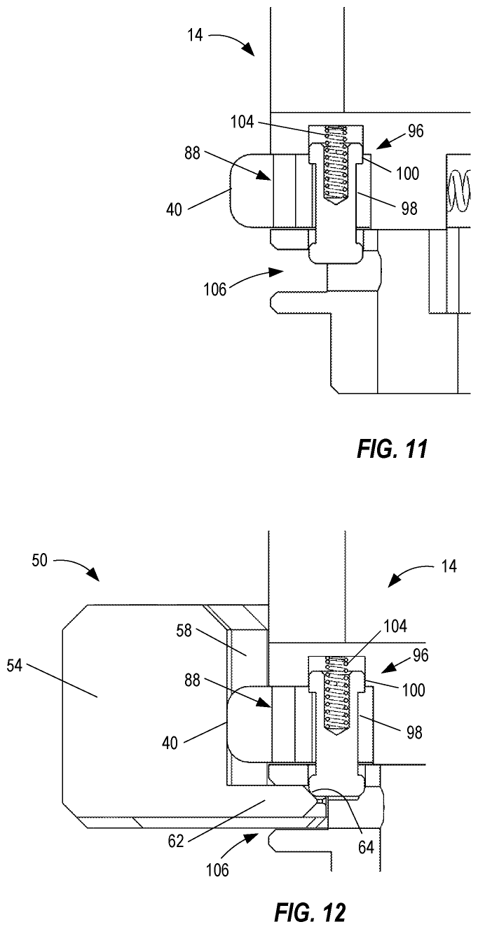

FIG. 11 shows the manual actuation lock-out pin 96 in the second longitudinal position, preventing or locking out manual actuation of the tool unit 14. The manual actuation lock-out pin 96 is biased to this position by the lock-out pin spring 104. Because nothing prevents movement of the manual actuation lock-out pin 96 to this second longitudinal position, it will assume this position every time the tool unit 14 is withdrawn from the tool stand 40. Manual actuation lock-out is thus the default configuration of the tool unit 14. Note the introduction in this drawing view of the tool stand slot 106 formed in the tool unit 14. Each tool stand slot 106 (one on each side of the tool unit 14) accepts the horizontal support shelf 62 on the lower inner surfaces of each arm 54 of the tool stand 50.

FIG. 12 shows the tool unit 14 partially, but not completely, disposed in the tool stand 50, with the horizontal support shelf 62 at the base of the arm 54 of the tool stand 50 engaging the tool stand slot 106. In particular, the tool unit 14 is shown at some point along the angled decoupling surface 58 of each arm 54 of the tool stand 50 (FIG. 2). The ramp 64 formed on the inner surface of the horizontal support shelf 62 engages the lower end of the manual actuation lock-out pin 96. As the tool unit 14 travels further into the arms 54 of the tool stand 50, the ramp 64 pushes the manual actuation lock-out pin 96 further towards the first longitudinal position (upwards, in FIG. 12), which it reaches as the angled decoupling surfaces 58 press the engagement edges 40 of the sliding wedges 70 into the housing 30. When fully inserted into the tool stand 50, with the tool unit 14 resting in the arcuate holding surfaces 60, the central shaft 98 of the manual actuation lock-out pin 96 is seated in the manual actuation lock-out slot 88, as shown in FIG. 10 and the right side of FIG. 9.

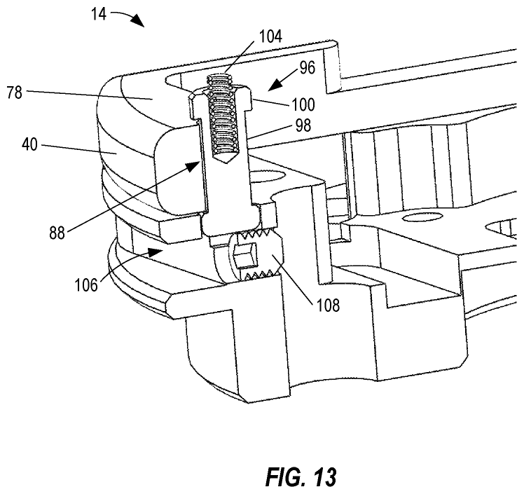

FIG. 13 shows the tool unit 14 configured to disable the manual actuation lock-out—that is, enable manual decoupling of a robotic tool. A set screw 108 is inserted in a threaded hole below the manual actuation lock-out pin 96. The set screw 108 holds the manual actuation lock-out pin 96 in the first longitudinal position, where the smaller diameter central shaft 98 is aligned with the manual actuation lock-out slot 88, allowing the tool unit 14 to be manually decoupled. The set screw 108 prevents the manual actuation lock-out pin 96 from moving to the second longitudinal position, where the larger diameter lock-out cap 100 would prevent manual decoupling by not fitting within the manual actuation lock-out slot 88. Those of skill in the art will readily understand that any mechanism to prevent movement of the manual actuation lock-out to the second longitudinal position may be substituted for the set screw 108. For example, a stop surface may be slidably or rotatably moveable between a blocking position and a non-blocking position, such as by actuation of a lever or similar device on the tool unit. Actuation of the stop surface may, in some aspects, require a key or specialized tool, to prevent causal of inadvertent disabling of the manual actuation lock-out mechanism.

The robotic tool changer 10 according to aspects of the present disclosure is thus selectively configurable to enable, or alternatively to disable or lock out, manual decoupling of a robotic tool. The default is manual actuation lock-out, where the tool unit 14 can assume the decoupled state only when it is stowed in the tool stand 50.

The tool unit 14 includes two manual actuation lock-out pins 96, one positioned adjacent the manual actuation lock-out slot 88 in each sliding wedge 70. However, the manual actuation lock-out mechanism would still work if only one manual actuation lock-out pin 96 were installed. If only one sliding wedge 70 is prevented from moving to the decouple position, as discussed above, the tool unit 14 will still remain coupled to the robot unit 12. Accordingly, even if, for example, one lock-out pin spring 104 were to break or otherwise fail, or some other malfunction occurred to one manual actuation lock-out pin 96, the inherent safety of the manual actuation lock-out mechanism is still achieved.

Embodiments of the present disclosure present significant advantages over the prior art, and may achieve one or more of the following technical effects. The mechanically actuated robotic tool changer 10 securely couples a robotic tool to an actuator, such as a robot arm. The tool changer 10 is compact, saving space and weight in the robot tooling stack. Mechanical actuation obviates the need for an electrical, pneumatic, etc., power source. The tool changer 10 can include some utility passing, such as via pins 42 and contacts 24, and conventional utility-passing modules may be affixed to the tool changer 10 externally. For safety, the tool unit 14 is biased to the coupled state by default, and can only be decoupled from the robot unit 12 by pressing the actuating edges 40. In a default configuration of the manual lock-out mechanism, this decoupling action can only be accomplished when the tool unit 14 is securely stowed in a tool stand 50; manual decoupling or decoupling by robot crash are mechanically prevented. The tool unit 14 can be configured to disable the manual lock-out mechanism—allowing manual decoupling of robotic tools—by insertion of two set screws 106. The single robotic tool changer 10 thus fulfils two distinct needs in the robotics industry regarding safety, with one configurable device. In the configuration where manual lock-out is disabled, even if one actuating edge 40 is pressed by accident, the tool unit 14 does not fully decouple, and will still retain connection to the robot unit 12.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description.

As used herein, the term “configured to” means set up, organized, adapted, or arranged to operate in a particular way; the term is synonymous with “designed to,” or in the case of processing circuitry and/or software, “programmed to.”

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A mechanically actuated robotic tool changer system, comprising:
a robot unit configured to be connected to an actuator and comprising a locking post;
a tool unit having a housing and configured to be connected to a robotic tool, having a central recess, and comprising a pair of sliding wedges in inverted and longitudinally opposite configuration to each other, the sliding wedges being biased apart from each other to assume a default coupled state in which the locking post of the robot unit is captured in the central recess of the tool unit to couple the tool unit to the robot unit, and moveable towards each other to assume a decoupled state in which the locking post of the robot unit is released.

2. The system of claim 1, wherein
the locking post of the robot unit comprises a locking shaft having a first diameter and an engagement cap rigidly affixed to the locking shaft and having a second diameter greater than the first diameter; and
in the decoupled state, the sliding wedges form a first effective diameter of the central recess that is larger than the diameter of the engagement cap; and
in the coupled state, the sliding wedges form a second effective diameter of the central recess that is smaller than the diameter of the engagement cap, but larger than the diameter of the locking shaft.

3. The system of claim 2 wherein
each sliding wedge comprises an actuating edge, which protrudes outwardly of the tool unit housing in the coupled state, and is flush with the tool unit housing in the decoupled state.

4. The system of claim 3, wherein each sliding wedge comprises
an engagement end having an engagement surface in the inner edge thereof and having a first width between the outer side edges thereof;
an actuating end having an actuating edge on the outer edge thereof, and defining an inner space having a width at least partially greater than the first width; and
two side rails connecting the engagement end and the actuating end.

5. The system of claim 4 whereby, when two sliding wedges assume the inverted and longitudinally opposite configuration to each other, the engagement end of one sliding wedge is configured to move into and out of the inner space of the actuating end of the other sliding wedge, and vice versa; and further comprising mainsprings configured to bias the sliding wedges outwardly apart from each other.

6. The system of claim 5 wherein
when the two sliding wedges move outwardly apart from each other under the bias of the mainsprings, the engagement surfaces of the two sliding wedges move closer together, and in the coupled state form the second effective diameter of the central recess of the tool unit; and
when the two sliding wedges move inwardly toward from each other by an external force pressing the actuating edges, the engagement surfaces of the two sliding wedges move further apart, and in the decoupled state form the first effective diameter of the central recess of the tool unit.

7. The system of claim 6 further comprising a manual actuation lock-out mechanism, comprising
a manual actuation lock-out slot formed in the actuating end of each sliding wedge; and
at least one manual actuation lock-out pin comprising a central shaft having a first diameter less than a width of the manual actuation lock-out slot and a lock-out cap having a second diameter greater than the width of the manual actuation lock-out slot;
wherein the manual actuation lock-out pin is disposed within the housing of the tool unit and aligned with the manual actuation lock-out slot of a sliding wedge;
wherein the manual actuation lock-out pin is movable in a longitudinal direction transverse to the plane of the sliding wedge, between a first longitudinal position and a second longitudinal position, and biased towards the second longitudinal position;
wherein in the first longitudinal position, the lock-out cap is positioned out of the plane of the sliding wedge, and the central shaft enters the manual actuation lock-out slot upon the sliding wedge moving inwardly to assume the decoupled state; and
wherein in the second longitudinal position, the lock-out cap is positioned adjacent the manual actuation lock-out slot, preventing the sliding wedge from moving inwardly to assume the decoupled state.

8. The system of claim 7 further comprising a set screw removably disposed in the tool unit housing, the set screw positioned and configured to prevent the manual actuation lock-out pin from moving to the second longitudinal position.

9. The system of claim 7 further comprising a tool stand configured to hold and support the tool unit and attached robotic tool, and further configured to press the sliding wedges towards each other to place the tool unit in a decoupled state, the tool stand configured to move the manual actuation lock-out pin from the second longitudinal position to the first longitudinal position as the tool unit moves into the tool stand.

10. The system of claim 9 wherein the tool stand comprises two fork arms, the inner surface of each fork arm comprising:
an engagement surface configured to accept the tool unit and guide it into the center of the tool stand;
an angled decoupling surface angled so as to decrease the distance between the inner walls of the two fork arms as the tool unit moves into the tool stand, and configured to progressively depresses the actuating edges as the tool unit moves further into the tool stand; and
an arcuate holding surface shaped to conform to the outer diameter of the tool unit housing, and configured to hold the tool unit when it is fully inserted into the tool stand;
whereby the angled decoupling surface is configured to transition the tool unit from the coupled state to the decoupled state as the tool unit moves into the tool stand, and the arcuate holding surface is configured to maintain the tool unit in the decoupled state while it is disposed in the tool stand.

11. The system of claim 10, wherein the engagement surface, angled decoupling surface, and arcuate holding surface of the tool stand are vertical surfaces, and wherein the tool stand further comprises a horizontal support shelf extending horizontally inwardly at the lower extent of the engagement surface, angled decoupling surface, and arcuate holding surface, wherein the horizontal support shelf is configured to engage a tool stand slot in the tool unit as the tool unit enters tool stand, and to support the weight of the tool unit and attached robotic tool when the tool unit is in the decoupled state.

12. The system of claim 11, wherein the tool stand further comprises a ramp formed in the inner edge of the horizontal support shelf, the ramp gradually transitioning from a distance below the upper surface of the horizontal support shelf at the front of the engagement surface, to being even with the upper surface of the horizontal support shelf at the back of the angled decoupling surface, wherein the ramp is configured to engage the manual actuation lock-out pin, and move the manual actuation lock-out pin from the second longitudinal position to the first longitudinal position as the tool unit moves into the tool stand.

13. The system of claim 1 wherein the sliding wedges are geometrically identical.

14. A mechanically actuated robotic tool changer, comprising:
a robot unit configured to be connected to an actuator and comprising a locking post;
a tool unit having a housing and configured to be connected to a robotic tool, having a central recess, and comprising a pair of geometrically identical sliding wedges in inverted and longitudinally opposite configuration to each other, the sliding wedges being biased apart from each other to assume a default coupled state in which the locking post of the robot unit is captured in the central recess of the tool unit to couple the tool unit to the robot unit, and moveable towards each other to assume a decoupled state in which the locking post of the robot unit is released; and
a manual actuation lock-out mechanism configured to disable manual actuation of the sliding wedges from the coupled state to the decoupled state, wherein actuation of the sliding wedges from the coupled state to the decoupled state can only occur by placing the tool unit in an associated tool stand.

15. The tool changer of claim 14 wherein the manual actuation lock-out mechanism is configured to be disabled by insertion of a set screw into the tool unit, whereby when the manual actuation lock-out mechanism is disabled, the sliding wedges can be actuated from the coupled state to the decoupled state when the tool unit is not disposed in the tool stand.

16. The tool changer of claim 15 further comprising a manual actuation lock-out pin movable between a first longitudinal position in which it allows the sliding wedges to move from the coupled state to the decoupled state and a second longitudinal position in which it prevents the sliding wedges to from moving from the coupled state to the decoupled state, wherein the manual actuation lock-out pin is moved to the first longitudinal position by interaction with the tool stand, and wherein the manual actuation lock-out pin is biased towards the second longitudinal position and hence assumes the second longitudinal position upon removal of the tool unit from the tool stand.

17. The tool changer of claim 16, wherein the set screw is positioned and configured to prevent the manual actuation lock-out pin from assuming the second longitudinal position.
